(19) United States
(12) Patent Application Publication
(10) Pub. No.: US 2005/0233900 A1
(43) Pub. Date: Oct. 20, 2005

(54) Dry delivery hypochlorite

(76) Inventors: William L. Smith, Oakland, CA (US); Maria G. Ochomogo, Oakland, CA (US)

Correspondence Address: THE CLOROX COMPANY, 1221 BROADWAY PO BOX 2351, OAKLAND, CA, 94623, US

(21) Appl. No.: 11/111,012

(22) Filed: Apr. 21, 2005

Related U.S. Application Data
(63) Continuation-in-part of application No. 10/828,571, filed on Apr. 20, 2004.

(51) Int. Cl. B01J 20/16

(52) U.S. Cl. 502/407

(57) ABSTRACT

This invention relates to dry powder forms of hypohalite, especially a dry powdered form of dilute or concentrated hypochlorite and hypochlorous acid compositions. The invention also relates to uses for these dry powders, such as for treating hard and soft inanimate surfaces, animate surfaces, air, and for deactivating allergens.

### CROSS REFERENCE TO RELATED APPLICATIONS

The present application is a continuation-in-part of Co-pending application Ser. No. 10/828,571, filed Apr. 20, 2004, which is incorporated within.

### BACKGROUND OF THE INVENTION

1. Field of the Invention

This invention relates to dry powder forms for hypohalite, especially a dry powdered form of dilute hypochlorite and hypochlorous acid compositions. The invention also relates to uses for these dry powder forms of hypohalite.

2. Description of the Related Art

U.S. Pat. No. 6,716,885 to Twydell et al., U.S. Pat. No. 5,342,597 to Tunison, III, U.S. Pat. No. 3,393,155 to Schutte et al. and U.S. Pat. No. 4,008,170 to Allan describe water dispersed in hydrophobic silica particles to give what is sometimes referred to as “dry water”. U.S. Pat. App. 2003/0160209 to Hoffman et al. describes the preparation of “dry oxone” from 1 N oxone solution and treated fumed silica. The “dry oxone” is useful in preventing collateral damage in detoxifying hazardous materials.

U.S. Pat. App. 2003/0156980 to Fischer et al. produced thickened solutions of 2.7-3% hypochlorite using fumed silica and optional additional thickeners. U.S. Pat. Appl. 2002/0179884 to Hoshino et al. found that dilute concentration hypochlorite solutions create difficulties in obtaining a formulation with satisfactory storage stability. Dry delivery of concentrated or dilute hypochlorite solutions has not been previously achieved.

### SUMMARY OF THE INVENTION

In accordance with the above objects and those that will be mentioned and will become apparent below, one aspect of the present invention is a powder comprising:
a. greater than 10% water;
b. a hypohalite compound; and
c. an inorganic solid.

In accordance with the above objects and those that will be mentioned and will become apparent below, another aspect of the present invention comprises a powder comprising:
a. greater than 50% water;
b. a compound selected from the group consisting of hypochlorite, hypochlorous acid, and combinations thereof; and
c. silica.

In accordance with the above objects and those that will be mentioned and will become apparent below, another aspect of the present invention comprises a kit comprising:
a. a powder composition; and
b. a set of instructions;
c. wherein said powder composition comprises greater than 50% water and a hypohalite compound.

Further features and advantages of the present invention will become apparent to those of ordinary skill in the art in view of the detailed description of preferred embodiments below.

### DETAILED DESCRIPTION

Before describing the present invention in detail, it is to be understood that this invention is not limited to particularly exemplified systems or process parameters that may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

It must be noted that, as used in this specification and the appended claims, the singular forms “a,” “an” and “the” include plural referents unless the content clearly dictates otherwise. Thus, for example, reference to a “surfactant” includes two or more such surfactants.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

In the application, effective amounts are generally those amounts listed as the ranges or levels of ingredients in the descriptions, which follow hereto. Unless otherwise stated, amounts listed in percentage (“%'s”) are in weight percent (based on 100% active) of the cleaning composition alone, not accounting for the substrate weight. Each of the noted cleaner composition components and substrates is discussed in detail below.

As used herein, the term “substrate” is intended to include any web, which is used to clean an article or a surface. Examples of cleaning sheets include, but are not limited to, mitts, webs of material containing a single sheet of material which is used to clean a surface by hand or a sheet of material which can be attached to a cleaning implement, such as a floor mop, handle, or a hand held cleaning tool, such as a toilet cleaning device.

As used herein, “wiping” refers to any shearing action that the substrate undergoes while in contact with a target surface. This includes hand or body motion, substrate-implement motion over a surface, or any perturbation of the substrate via energy sources such as ultrasound, mechanical vibration, electromagnetism, and so forth.

The term “cleaning composition”, as used herein, is meant to mean and include a cleaning formulation having at least one surfactant.

As used herein, the terms “nonwoven” or “nonwoven web” means a web having a structure of individual fibers or threads which are interlaid, but not in an identifiable manner as in a knitted web. Nonwoven webs have been formed from many processes, such as, for example, meltblowing processes, spunbonding processes, and bonded carded web processes.

The term “surfactant”, as used herein, is meant to mean and include a substance or compound that reduces surface tension when dissolved in water or water solutions, or that reduces interfacial tension between two liquids, or between a liquid and a solid. The term “surfactant” thus includes anionic, nonionic and/or amphoteric agents.

Fumed Silica

Fumed silica is formed by burning a volatile silicon compound. This forms primary particles of a few silicon oxide units with a size about 10 nm. These primary particles fuse together to form aggregates with a particle size on the order of 200 nm. These aggregates associate to form agglomerates that are bound by long-range intermolecular forces such as van der Waals forces. The agglomerates have typical particles sizes between 5 and 100 μm. In order to coat water droplets, about 50% or more of the surface silanol groups are typically blocked so they can not ionize, form hydrogen bonds, or otherwise interact with water. The most common approach is to react the silanol groups with silylating agents such as hexamethyldisilazane or polydimethylsiloxane. This converts the surface silanol groups into trimethylsilyl groups. Other agents that are commonly used to block surface silanol groups include trimethylchlorosilane, dimethyldichlorosilane, octamethylcyclotetrasiloxane, alkylsilanes (e.g. octylsilane and hexadecysilane), vinylsilanes (e.g. acrylsilane and methacrylsilane), and similar compounds. The surface silanol groups can also be blocked by association with organic cations or organic polycations (e.g. long chain alkyl amines, quaternary ammonium compounds, or carbamates); by association with polyvalent cations that are also ionically bound to organic ligands (e.g. aluminum stearate, chromium oleate, chromium methacrylate and other metal ions that are complexed to soaps or other anionic organic compounds); by esterification with alcohols or phenols (e.g. methanol, isopropanol, n-butanol, diazomethane, and many other similar compounds); and by association with various types of organic polymers (e.g. polymers formed on a silica surface using polyisocyanate and a polyol, using aldehydes, or using carbodiimides).

Generally, at least 50% of the surface silanol groups need to be blocked. However, decreasing the amount of unblocked surface silanol groups increases the maximum ionic strength and the maximum pH that can be tolerated. The pKa for treated fumed silica is unknown, but results for silica gel shows that as the surface silanol groups are partially neutralized, the pKa of the unneutralized groups increase. In other words, while the pKa of polymeric silica gel is about 6.5, as the silanol groups are neutralized the pKa of the remaining silanol groups approach the first dissociation constant for mono silicic acid (pH 9.8). With treated fumed silica, the pKa could be higher since the dissociation of the second, third, and fourth hydrogens of silicic acid have pKa 12-13. In all of these cases, increasing ionic strength would be expected to decrease the pKa and increase the ionization of unblocked silanol groups. Since data is not available for treated silicas, it had to be confirmed that pH and ionic strength had an impact on particle formation. Also, the critical values of pH and ionic below which particles can be formed with a specific type of treated fumed silica must be empirically determined.

Hypohalous Acid and Salts

Suitable hypohalous acids and salts may be provided by a variety of sources, including compositions that lead to the formation of positive halide ions and/or hypohalite ions; hypohalous acid, hypohalous acid salt, hypohalous acid generating species, hypohalous acid salt generating species; as well as compositions that are organic based sources of halides, such as chloroisocyanurates, haloamines, haloimines, haloimides and haloamides, or mixtures thereof. These compositions may also produce hypohalous acid or hypohalite species in situ. Suitable hypohalous acids and salts for use herein include the alkali metal and alkaline earth metal hypochlorites, hypobromites, hypoiodites, chlorinated trisodium phosphate dodecahydrates, potassium and sodium dichloroisocyanurates, potassium and sodium trichlorocyanurates, N-chloroimides, N-chloroamides, N-chlorosulfamide, N-chloroamines, chlorohydantoins such as dichlorodimethyl hydantoin and chlorobromo dimethylhydantoin, bromo-compounds corresponding to the chloro-compounds above, and compositions which generate the corresponding hypohalous acids, or mixtures thereof.

In one embodiment, said hypohalite composition comprises an alkali metal and/or alkaline earth metal hypochlorite, or mixtures thereof. Compositions may comprise an alkali metal and/or alkaline earth metal hypochlorite selected from the group consisting of sodium hypochlorite, potassium hypochlorite, magnesium hypochlorite, lithium hypochlorite and calcium hypochlorite, and mixtures thereof.

The anodic oxidation of chloride in an electrolysis cell results in the production of a number of oxychlorine ions including hypochlorite, chlorite, chlorate, and perchlorate. Chlorite is readily oxidized to chlorate. Perchlorate may be an undesirable contaminant in the environment due to its low reactivity, high mobility, and inhibition of thyroid function. The production of hypochlorite via chlorination of caustic water is not believed to result in the formation of perchlorate. This route may be advantageous for certain uses where minor amounts of perchlorate would be undesirable.

The compositions of the invention can be diluted prior to use from a concentrated liquid or solid composition. For instance, liquid sodium hypochlorite optionally containing surfactants or other additives of 5.25% available chlorine concentration can be diluted to below 500 ppm available chlorine concentration. Tablets or powders having solid hypochlorite or hypochlorite generators can be dissolved in water to deliver compositions below 500 ppm concentration. Examples of compositions that can be diluted are described in U.S. Pat. No. 6,297,209, U.S. Pat. No. 6,100,228, U.S. Pat. No. 5,851,421, U.S. Pat. No. 5,688,756, U.S. Pat. No. 5,376,297, U.S. Pat. No. 5,034,150, U.S. Pat. No. 6,534,465, U.S. Pat. No. 6,503,877, U.S. Pat. No. 6,416,687, U.S. Pat. No. 6,180,583, and U.S. Pat. No. 6,051,676.

The hypohalous acids and salt composition may be an equilibrium mixture of hypochlorous acid and sodium hypochlorite. The active species is present in an amount from above zero to about 10 weight percent of the composition, or from about 0.001 weight percent (10 ppm) to about 1 weight percent of the composition, or from about 0.005 (50 ppm) to about 0.05 weight percent of the composition.

Preparation of Compositions

Compositions can be prepared as described in U.S. Pat. App. 2003/0160209 to Hoffman et al., U.S. Pat. No. 6,716,885 to Twydell et al., U.S. Pat. No. 5,342,597 to Tunison, III, U.S. Pat. No. 3,393,155 to Schutte et al., and U.S. Pat. No. 4,008,170 to Allan, which are incorporated by reference herein. In accordance with the invention, solutions of dilute hypochlorite are coated using small quantities of treated (hydrophobic) particles by either vigorous agitation or by aerosolization of the solution in the presence of hydrophobic particles to form a solid powder. For example, when hydrophobic fumed silica particles, for example “Cab-O-Sil TS-530® are shaken in the presence of 100 ppm hypochlorite solution in approximately a 95:5-weight ratio of solution to silica, a dry powder can form. Also, a weight ratio of 80:20 can be utilized. The hydrophobic silica forms a porous coating of insoluble fine particles around the solution. Alternately, other colloidal particles or nanoparticles, such as alumina or clays, could be treated with a hydrophobic chemical to alter their surface characteristics and then used to encapsulate the hypochlorite solutions.

Free flowing powders containing at least 90% of aqueous solutions of sodium hypochlorite or hypochlorous acid and other optional water soluble salts, buffers, and pH control agents can be formed by mixing said solutions with hydrophobic fumed silica. Suitable hydrophobic fumed silica typically have at least 50% of the silanol groups in the parent fumed silica converted to alkyl siloxy groups or otherwise blocked so they can not interact with water. Further reducing the number of surface silanol groups increases the maximum pH and the ionic strength of the solution that can be coated by the hydrophobic fumed silica. The particles of powdered hypochlorite form spontaneously when the solution is mixed with the silica using enough shear to form water droplets less than about 20 μm in diameter and to break apart the weakly associated silica agglomerates into their fused aggregates of primary particles. The resulting particles break apart when rubbed against a surface to release hypochlorite. Thus, they may be used to clean and to disinfect articles and surfaces. This includes household surfaces and laundry. The hydrophobic silica particles may also have cleaning benefits, either as an abrasive, or by absorbing oils and hydrophobic soils.

The particles do not release hypochlorite until they are disrupted which allows careful control of where they are applied to prevent damage to sensitive areas. They could be applied with a pen-type applicator or some other device. The particles are small enough to adhere to nonwoven material to form hypochlorite-impregnated cleaning wipes or a disposable head for a cleaning wand. The particles can be dispersed in an organic phase such as a cream or a lotion to provide sanitization of hands or removal of odors from feet or underarms. The particles allow the escape of hypochlorous acid vapor, so they may be used as a source of volatile disinfectant which may be used to control odors and the growth of microorganisms on food in food storage containers, on articles stored in bags, dressers, closets, etc., on dirty laundry stored in hampers, diapers stored in diaper pails, on trash or garbage in waste containers, and on animal litter such as cat litter. In addition to controlling microorganisms the hypochlorous acid vapors also prevent odors due to the growth of microorganisms as well as eliminating many odors from other sources. Since hypochlorite destroys allergens, the particles may be particularly useful for treating carpets, upholstery and drapery. The particles are small enough to be applied from an aerosol dispenser as well as a shaker can. Combining the ability of allergen destruction and the release of hypochlorous acid may reduce airborne allergens in the vicinity of pet areas such as rodent cages, dog kennels, and cat boxes.

The particles also expand the possibility of formulating hypochlorite-containing products with other ingredients. The dry particles can be combined with a variety of other dry ingredients that will be kept separate until used. When used the particles will rupture and allow the hypochlorite solution to mix with the other components. These components may only be stable for a brief period when mixed with hypochlorite. They other components could also destroy the hypochlorite after a desired contact time to prevent residual odors or to protect sensitive surfaces from excess exposure to hypochlorite. The destruction could be accomplished by the slow release of a reactive substance such as a reducing agent or a pH control agent that controls the reaction rate with another substance.

The amount of available halogen oxidant in the composition is determined by placing samples of the composition into about 50 milliliters of distilled water, followed by addition of about 10 milliliters of a 10 weight/weight percent solution of potassium iodide and addition of about 10 milliliters of a 10 volume percent solution of sulfuric acid, the resulting mixture being well stirred. The resulting yellow to brown solution, whose color is the result of oxidation of free iodine ion (I⁻) to molecular iodine (I₂), was then volumetrically titrated to an essentially colorless endpoint by addition of standardized 0.1 Molar sodium thiosulfate (Na₂S₂O₃) titrant. Calculation then expresses the result as percent of available molecular chlorine (Cl₂), that is to say assigning two equivalents per mole of titrated hypohalite oxidant. Stability results are then expressed by repeated assays over time using identically prepared samples resulting from the same composition, normalized to 100 percent representative of the starting available chlorine measured initially.

Surfactants

The composition of the invention may contain surfactants. The surfactants should be stable to hypohalous acid or hypohalous acid salt unless they are physically isolated. Examples of surfactants having relatively good stability can be found in U.S. Pat. Nos. 6,413,925 and 5,851,421.

The composition may contain one or more surfactants selected from anionic, nonionic, cationic, ampholytic, amphoteric and zwitterionic surfactants and mixtures thereof. A typical listing of anionic, nonionic, ampholytic, and zwitterionic classes, and species of these surfactants, is given in U.S. Pat. No. 3,929,678 to Laughlin and Heuring. A list of suitable cationic surfactants is given in U.S. Pat. No. 4,259,217 to Murphy. Where present, ampholytic, amphoteric and zwitteronic surfactants are generally used in combination with one or more anionic and/or nonionic surfactants. The surfactants may be present at a level of from about 0% to 90%, or from about 0.001% to 50%, or from about 0.01% to 25% by weight.

Solvent

The composition of the invention may contain solvents. The solvents should be stable to hypohalous acid or hypohalous acid salt if long term storage is desired. If the solutions of the composition are generated prior to use, then solvents having less stability may be used. The solvents can be present at a level of from 0.001% to 10%, or from 0.01% to 10%, or from 1% to 4% by weight.

Additional Adjuncts

The compositions optionally contain one or more of the following adjuncts: stain and soil repellants, lubricants, odor control agents, perfumes, fragrances and fragrance release agents, brighteners, and fluorescent whitening agents. Other adjuncts include, but are not limited to, acids, electrolytes, dyes and/or colorants, solubilizing materials, stabilizers, thickeners, defoamers, hydrotropes, cloud point modifiers, preservatives, and other polymers. The solubilizing materials, when used, include, but are not limited to, hydrotropes (e.g. water soluble salts of low molecular weight organic acids such as the sodium and/or potassium salts of toluene, cumene, and xylene sulfonic acid). The acids, when used, include, but are not limited to, mineral acids, organic hydroxy acids, citric acids, keto acid, and the like. Electrolytes, when used, include, calcium, sodium and potassium chloride. Thickeners, when used, include, but are not limited to, polyacrylic acid, xanthan gum, calcium carbonate, aluminum oxide, alginates, guar gum, methyl, ethyl, clays, and/or propyl hydroxycelluloses. Defoamers, when used, include, but are not limited to, silicones, aminosilicones, silicone blends, and/or silicone/hydrocarbon blends.

Preservatives, when used, include, but are not limited to, mildewstat or bacteriostat, methyl, ethyl and propyl parabens, phosphates such as trisodium phosphate, short chain organic acids (e.g. acetic, lactic and/or glycolic acids), bisguanidine compounds (e.g. Dantagard and/or Glydant) and/or short chain alcohols (e.g. ethanol and/or IPA). The mildewstat or bacteriostat includes, but is not limited to, mildewstats (including non-isothiazolone compounds) including Kathon GC, a 5-chloro-2-methyl-4-isothiazolin-3-one, KATHON ICP, a 2-methyl-4-isothiazolin-3-one, and a blend thereof, and KATHON 886, a 5-chloro-2-methyl-4-isothiazolin-3-one, all available from Rohm and Haas Company; BRONOPOL, a 2-bromo-2-nitropropane 1,3 diol, from Boots Company Ltd., PROXEL CRL, a propyl-p-hydroxybenzoate, from ICI PLC; NIPASOL M, an o-phenyl-phenol, Na⁺ salt, from Nipa Laboratories Ltd., DOWICIDE A, a 1,2-Benzoisothiazolin-3-one, from Dow Chemical Co., Nipacides from Clariant, and IRGASAN DP 200, a 2,4,4′-trichloro-2-hydroxydiphenylether, from Ciba-Geigy A.G.

Antimicrobial Agent

The composition of the invention may contain antimicrobial agents. The antimicrobial agents should be stable to hypohalous acid or hypohalous acid salt if long term storage is desired. If the solutions of the composition are generated prior to use, then antimicrobial agents having less stability may be used.

Antimicrobial agents include quaternary ammonium compounds and phenolics. Non-limiting examples of these quaternary compounds include benzalkonium chlorides and/or substituted benzalkonium chlorides, di(C₆-C₁₄)alkyl di short chain (C₁₋₄ alkyl and/or hydroxyalkl) quaternaryammonium salts, N-(3-chloroallyl) hexaminium chlorides, benzethonium chloride, methylbenzethonium chloride, and cetylpyridinium chloride. Other quaternary compounds include the group consisting of dialkyldimethyl ammonium chlorides, alkyl dimethylbenzylammonium chlorides, dialkylmethylbenzylammonium chlorides, and mixtures thereof. Biguanide antimicrobial actives including, but not limited to polyhexamethylene biguanide hydrochloride, p-chlorophenyl biguanide; 4-chlorobenzhydryl biguanide, halogenated hexidine such as, but not limited to, chlorhexidine (1,1′-hexamethylene-bis-5-(4-chlorophenyl biguanide) and its salts are also in this class.

Builder/Buffer

The composition of the invention may contain a builder or buffer. The builder or buffer should be stable to hypohalous acid or hypohalous acid salt if long term storage is desired. If the solutions of the composition are generated prior to use, then builders or buffers having less stability may be used.

The composition may include a builder or buffer, which can be used as a pH adjusting agent or as a sequestering agent in the composition. A variety of builders or buffers can be used and they include, but are not limited to, phosphate-silicate compounds, carbon dioxide or carbonate, zeolites, alkali metal, ammonium and substituted ammonium polyacetates, trialkali salts of nitrilotriacetic acid, carboxylates, polycarboxylates, carbonates, bicarbonates, polyphosphates, aminopolycarboxylates, polyhydroxysulfonates, and starch derivatives.

Builders or buffers can also include polyacetates and polycarboxylates. The polyacetate and polycarboxylate compounds include, but are not limited to, sodium, potassium, lithium, ammonium, and substituted ammonium salts of ethylenediamine tetraacetic acid, ethylenediamine triacetic acid, ethylenediamine tetrapropionic acid, diethylenetriamine pentaacetic acid, nitrilotriacetic acid, oxydisuccinic acid, iminodisuccinic acid, mellitic acid, polyacrylic acid or polymethacrylic acid and copolymers, benzene polycarboxylic acids, gluconic acid, sulfamic acid, oxalic acid, phosphoric acid, phosphonic acid, organic phosphonic acids, acetic acid, and citric acid. These builders or buffers can also exist either partially or totally in the hydrogen ion form.

The builder agent can include sodium and/or potassium salts of EDTA and substituted ammonium salts. The substituted ammonium salts include, but are not limited to, ammonium salts of methylamine, dimethylamine, butylamine, butylenediamine, propylamine, triethylamine, trimethylamine, monoethanolamine, diethanolamine, triethanolamine, isopropanolamine, ethylenediamine tetraacetic acid and propanolamine.

Buffering and pH adjusting agents, when used, include, but are not limited to, organic acids, mineral acids, alkali metal and alkaline earth salts of silicate, metasilicate, polysilicate, borate, hydroxide, carbonate, carbamate, phosphate, polyphosphate, pyrophosphates, triphosphates, tetraphosphates, ammonia, hydroxide, monoethanolamine, monopropanolamine, diethanolamine, dipropanolamine, triethanolamine, and 2-amino-2methylpropanol. Preferred buffering agents for compositions of this invention are nitrogen-containing materials. Some examples are amino acids such as lysine or lower alcohol amines like mono-, di-, and tri-ethanolamine. Other preferred nitrogen-containing buffering agents are tri(hydroxymethyl) amino methane (TRIS), 2-amino-2-ethyl-1,3-propanediol, 2-amino-2-methyl-propanol, 2-amino-2-methyl-1,3-propanol, disodium glutamate, N-methyl diethanolamide, 2-dimethylamino-2-methylpropanol (DMAMP), 1,3-bis(methylamine)-cyclohexane, 1,3-diamino-propanol N,N′-tetramethyl-1,3-diamino-2-propanol, N,N-bis(2-hydroxyethyl)glycine (bicine) and N-tris(hydroxymethyl)methyl glycine (tricine). Other suitable buffers include ammonium carbamate, citric acid, acetic acid. Mixtures of any of the above are also acceptable. Useful inorganic buffers/alkalinity sources include ammonia, the alkali metal carbonates and alkali metal phosphates, e.g., sodium carbonate, sodium polyphosphate. For additional buffers see WO 95/07971, which is incorporated herein by reference. Other preferred pH adjusting agents include sodium or potassium hydroxide.

When employed, the builder, buffer, or pH adjusting agent comprises at least about 0.001% and typically about 0.01-5% of the cleaning composition. Preferably, the builder or buffer content is about 0.01-2%.

Fragrance

The composition of the invention may contain fragrance. The fragrance should be stable to hypohalous acid or hypohalous acid salt if long term storage is desired. If the solutions of the composition are generated prior to use, then fragrances having less stability may be used.

Compositions of the present invention may comprise from about 0.001% to about 5% by weight of the fragrance. Compositions of the present invention may comprise from about 0.005% to about 2.5% by weight of the fragrance. Compositions of the present invention may comprise from about 0.01% to about 1% by weight of the fragrance.

Water and pH

The water should be present at a level of less than about 99.999%. The water may be deionized, filtered to remove impurities including metals and organic carbon, purified by reverse osmosis, purified by distillation, or any combination thereof. Purified water may be prepared by a process selected from the group consisting of sodium cation exchange, hydrogen cation exchange, reverse osmosis, activated carbon treatment, UV light treatment, UVC, ozone treatment, chlorination, ultrafiltration, nanofiltration, electrodialysis, and a combination thereof. During preparation there may be a need for hygiene and segregation to prevent the introduction of compounds that are oxidized by hypochlorite since these become more important at low concentrations where the loss of a few ppm may be significant.

The composition may be adjusted for pH using a pH adjusting agent. Suitable pH adjusting agents include carbon dioxide, alkali metal carbonate, alkali metal bicarbonate, alkali metal silicates, alkali metal hydroxide, alkali phosphate salt, alkaline earth phosphate salt, alkali borate salt, hydrochloric acid, nitric acid, sulfuric acid, alkali metal hydrogen sulfate, acetic acid, vinegar from various sources, other carboxylic acids, polycarboxylates, organic sulfonic acids, sulfamic acid, amine, alkyl amine, dialkyl amine, and trialkyl amine. The composition may have a pH from 1 to 13. The composition may have a pH from 2 to 12. The composition may have a pH from 2 to 5. The composition may have a pH from 5 to 8. The composition may have a pH from 6 to 8. The composition may have a pH from 6 to 7.5. The composition may have a pH from 9 to 13. The composition may have a pH from 10 to 12.

Cleaning Substrate

A wide variety of materials can be used as the cleaning substrate. The substrate should have sufficient wet strength, abrasivity, loft and porosity. Examples of suitable substrates include, nonwoven substrates, wovens substrates, hydroentangled substrates, foams and sponges. Any of these substrates may be water-insoluble, water-dispersible, or water-soluble. Suitable substrates are described in Co-pending application Ser. No. 10/882001, which was filed Jun. 29, 2004, entitled “Cleaning Pad with Functional Properties”, and incorporated herein.

Methods of making nonwovens are well known in the art. Generally, these nonwovens can be made by air-laying, water-laying, meltblowing, coforming, spunbonding, or carding processes in which the fibers or filaments are first cut to desired lengths from long strands, passed into a water or air stream, and then deposited onto a screen through which the fiber-laden air or water is passed. The air-laying process is described in U.S. Pat. App. 2003/0036741 to Abba et al. and U.S. Pat. App. 2003/0118825 to Melius et al. The resulting layer, regardless of its method of production or composition, is then subjected to at least one of several types of bonding operations to anchor the individual fibers together to form a self-sustaining substrate. In the present invention the nonwoven substrate can be prepared by a variety of processes including, but not limited to, air-entanglement, hydroentanglement, thermal bonding, and combinations of these processes.

The following patents are incorporated herein by reference for their disclosure related to nonwovens: U.S. Pat. No. 3,862,472; U.S. Pat. No. 3,982,302; U.S. Pat. No. 4,004,323; U.S. Pat. No. 4,057,669; U.S. Pat. No. 4,097,965; U.S. Pat. No. 4,176,427; U.S. Pat. No. 4,130,915; U.S. Pat. No. 4,135,024; U.S. Pat. No. 4,189,896; U.S. Pat. No. 4,207,367; U.S. Pat. No. 4,296,161; U.S. Pat. No. 4,309,469; U.S. Pat. No. 4,682,942; U.S. Pat. No. 4,637,859; U.S. Pat. No. 5,223,096; U.S. Pat. No. 5,240,562; U.S. Pat. No. 5,556,509; and U.S. Pat. No. 5,580,423.

Application

The composition may be stored, shipped, or applied in a variety of container materials, including glass, ABS, polycarbonate, high density polyethylene, low density polyethylene, high density polypropylene, low density polypropylene, polyethylene terephthalate, or polyvinylchloride. The composition may be dispersed into the air. The composition may be dispersed into air using an aerosol or an electrostatic sprayer, as described in WO01/20988. The composition can be applied by the various device described in U.S. Pat. App. File number 340.182C, filed Mar. 31, 2005 to Bitowft et al.

The composition may be applied to soft surfaces including clothing, bedding, upholstery, curtains, and carpets. The composition may be applied to soft surfaces by spraying, by wiping, or by direct application. The composition may be applied to hard surfaces including kitchen surfaces, bathroom surfaces, walls, floors, outdoor surfaces, automobiles, countertops, food contact surfaces, toys, food products including fruits and vegetables. The composition may be applied to hard surfaces by spraying, by wiping, or by direct application.

The composition may be applied on human and animal surfaces, including external skin areas and internal cavities. The composition may have lower skin sensitivity and may be appropriate to be taken orally or by inhalation. The composition may be applied to human and animal surfaces by spraying, by wiping, by direct application, by immersion, or as part of the normal treatment process. The compositon may be applied as a thickened gel. The composition may be applied using a device to direct its application, such as a bleach pen. The composition may be applied as a wound dressing.

The composition may be applied with a nonwoven substrate, wipe or cleaning pad on inanimate, household surfaces, including floors, counter tops, furniture, windows, walls, and automobiles. The composition may be applied to baby and children's items, including toys, bottles, pacifiers, etc. The composition may be applied with a nonwoven substrate, brush, sponge, wipe or cleaning pad on human and animal surfaces, including external skin areas and internal cavities. Other surfaces include stainless steel, chrome, and shower enclosures. The nonwoven substrate, wipe or cleaning pad can be packaged individually or together in canisters, tubs, etc. The nonwoven substrate, wipe or cleaning pad can be used with the hand, or as part of a cleaning implement attached to a tool or motorized tool, such as one having a handle. Examples of tools using a nonwoven substrate, wipe or pad include U.S. Pat. No. 6,611,986 to Seals, WO00/71012 to Belt et al., U.S. Pat. App. 2002/0129835 to Pieroni and Foley, and WO00/27271 to Policicchio et al.

For certain uses, for example, for human and animal surfaces, the composition may be thickened. The composition may be thickened using surfactant thickening, polymer thickening, or other means. Thickening may allow more controlled application or application from a device. The composition may be thicked to a viscosity of from 40 to 10,000 cps. Examples of thickened and unthickened compositions can be found in U.S. Pat. No. 6,162,371, U.S. Pat. No. 6,066,614, U.S. Pat. No. 6,153,120, U.S. Pat. No. 6,037,318, U.S. Pat. No. 6,313,082, U.S. Pat. No. 5,688,435, U.S. Pat. No. 6,413,925, U.S. Pat. No. 6,297,209, U.S. Pat. No. 6,100,228, U.S. Pat. No. 5,916,859, U.S. Pat. No. 5,851,421, U.S. Pat. No. 5,688,756, U.S. Pat. No. 5,767,055, U.S. Pat. No. 5,055,219, and U.S. Pat. No. 5,075,029.

Method of Use

The compositions may be used in personal care applications, including uses to treat wounds, rashes, acne, etc. Example of suitable uses include: sprinkling on wound before bandaging, treatment for urishol-indused rashes (e.g. poison ivy, poison oak), as a band-aid additive, as a wound cleaner and disinfectant, as a treatment for athlete's foot fungus, as a facial anti-acne defoliator, as a diaper rash preventer, as an acne facial wash powder, suspended as particles in a cream.

Other suitable personal care uses might include: a denture cleaner; a hand sanitizer/moisturizer, as a waterless hand sanitizer, as a anti-gingivitis toothpaste, as a tooth whitener including good for gums claim, as a foot powder deodorizer, as a mouth freshener, as a portable dry shower or deodorant, as a skin lightener for “age spots”, as a hand sanitizer and moisturizer. Other potential uses include treating odors caused by bacteria and mildew, as a shoe cleaner, gym disinfecting powder, as a diaper pail odor remover, as a fridge deodorizer/freshener, as a sachet placed in food container, as sachet drawer fresheners, shoe powder deodorizer, as an air freshener for cars, as a garbage deodorizer, as a laundry dryer clothes freshener, as a garbage disposal freshener, for use anywhere baking soda is used, in a kitty litter box, as a freshener to carpets. Other potential uses include as a travel sanitizer, including camping gear, to treat cutting boards, as a powder to drop into air ducts to clean air, for waterless baby toy disinfecting, for closet mildew prevention, and as a seed treatment. Other potential uses include for water treatment, including as an additive for swimming pools, for cut flower freshness, for use in water filters for removal of microorganisms, and for direct addition to water. Other potential uses include as a sprayable cleaning product, as a laundry detergent with bleach, to improve the odor control of an existing product, as a dry disinfecting wipe, in a direct bleach applicator device, as a dog/cat pet wash to treat odors, allergens, disinfectant, as an upholstery cleaner to treat allergens, odors, germs, for waterless dish washing, as an additive to diapers to prevent odors or disinfect. Other potential uses include incorporation into items for long term use, for example in a sponge treatment so that sponge releases bleach with use, as an anti-mold building material additive, as an additive for grout, and as an additive to air filters for antimicrobial efficacy. Other potential uses include treating pests, for example as an ant preventer or for garden dusting. Other potential uses include industrial uses, including contaminated spill clean-up, algae removal from drinking water containers for farming, treating sick building syndrome, and as a general purpose disinfectant for hospitals.

Cleaners

The compositions of the invention can be used in a direct application, sprayable or aerosolized product on hard surfaces, for cleaning, odor control, bleaching and sanitization. The compositions of the invention can be combined with other dry ingredient cleaners, for example, laundry detergents or abrasive cleansers. The compositions can be applied to a woven or nonwoven substrate and used as a dry disinfecting wipe, for odor control, as an additive to diapers, for waterless dishwashing, for touching up fabric and upholstery.

Allergen Deactivation

During the course of evaluating various oxidants and antimicrobials for their allergen deactivating ability, we have found that a very dilute solution (on the order of 40-80 ppm) of primarily hypochlorous acid can effectively deactivate allergens. Presumably the low levels of oxidant are still able to break up the allergen proteins, rendering them biologically inert.

While still extremely effective, the low concentration and nearly neutral pH (5-8) of the hypochlorous/hypochlorite mixture virtually eliminates surface damage. There is no sticky residue that can affect the feel of fabrics and there may be minimal dye damage. The solution may be aerosolized to treat air directly, or applied to surfaces.

Aerosols are known to have a low collision rate between denaturant and allergen particles. As a result, the denaturant must be used in high concentrations to be effective. Using this approach with conventional denaturants, which may be irritating or fragranced at high levels, can cause health problems.

Water Purification

The compositions of the invention can be used to purify water and make the water safe for consumption or recreational use. The compositions of the invention can be used for algae control. The compositions of the invention can be incorporated into water filters, for example, for use while camping or in disasters.

Food and Food Contact Surfaces

The compositions of the invention can be used for a direct food treatment, for cleaning food-contact surfaces, and for toxicologically safe cleaning. This may involve the use of additional food-safe ingredients, GRAS ingredients, or ingredients with low toxicologically impact. Methods describing this use and possible compositions can be found in U.S. Pat. No. 6,455,086, U.S. Pat. No. 6,313,049, U.S. 2002/0132742, U.S. 2001/0014655, WO99/00025, and U.S. 2002/0151452.

Personal Care

The compositions of the invention can be used to sterilize medical instruments. Dilute hypochlorite will discolor or degrade tubing and other sensitive parts to less extent than concentrated hypochlorite. The compositions may be used in kidney dialysis machines or as an irrigating agent in endodontic treatment. The compositions of the invention can be used to kill tumor cells, affect tumor cell recognition and to induce apoptosis.

The compositions of the invention can be used in agricultural applications, for example, seed and seedling treatments, dormant sprays for fruit trees, stored grain treatments, dips or sprays for any post-harvest plant material and their containers, treatments for soil, either on the land or in containers, treatments for transportation and storage to market, treatments for transportation, storage, and display at market (retail or wholesale), treatments for import and export regulations, and treatments for preventing the accidental introduction of alien pest organisms. The compositions of the invention can be used for the meat, poultry, dairy, seafood, and aquaculture industries, for example, equipment treatments, living quarters treatments, dips or sprays for eggs and containers, dips or sprays for meat and containers, treatments for rendering operations, treatments for transportation and storage to market, treatments for transportation, storage, and display at market (retail or wholesale), treatments for import and export regulations, treatments for preventing alien pest organisms from crossing borders, treating disease on live animals (terrestrial or aquatic), including udder treatments, and dips or sprays for milking equipment, transfer lines, and containers. The compositions of the invention can be used for homeland security, for example, treatments for preventing the intentional introduction of alien pest organisms or deadly human or animal organisms.

Plant Preservation

The compositions of the invention can be used to preserve and maintain the freshness of freshly cut flowers and other cut plants. The compositions of the invention can be used to prevent the build-up of microorganisms that contribute to the decaying of stems and abscission and scenesing of leaves and flowers. The compositions of the invention can be used to preserve and extend the shelf life of freshly cut fruits and vegetables such as cut melon, cantaloupe, strawberry, potatoes, etc. The compositions of the invention can be used to eradicate hepatitis virus A from fresh strawberries and other fruits and vegetables. The compositions of the invention can be used for in the sprout industry to treat seeds of various plants including alfalfa, wheat, barely and all other edible plant to control the spread of food-borne diseases such as Salmonella, E. coli, Campylobacter, etc. The compositions of the invention can be used in washing and treating shoes that have been moldy. The compositions of the invention can be used with sponges, cheesecloth, paper towel and other non-woven articles to clean and remove and kill mold, bacteria and viruses from soft and hard surfaces. The compositions of the invention can be used to control mold in school. The compositions of the invention can be used as a spray or wipe product. The compositions of the invention can be used to control the spread of germs on hard surfaces in school. The compositions of the invention can be used to control the spread of hepatitis among jails. The compositions of the invention can be used in laundry to kill germs. The compositions of the invention can be used in long-term care centers and public gyms, where, for example, they can be applied as a spray or wipe product on hard surfaces to kill all germs that are transmitted via environmental surfaces and human. The compositions of the invention can be used in laundry to disinfect towels, and other articles that carry germs. The compositions of the invention can be used for in public areas where, for example, they can be sprayed on a large scale in parks, streets, public places to control disease-causing agents such as SARS, calicivirus, enterovirus, FMD, and other viruses. The compositions of the invention can be used as wipes or spray to disinfect all environmental surfaces. The compositions of the invention can be used on ships and cruise ships where, for example, they can be used to control the spread if norwalk virus, calicivirus, and influenza virus. The compositions of the invention can be used to control cross contamination due to Salmonella and Campylobacter. The compositions of the invention can be used for to protect from biological warfare where, for example, they can be used to spray on humans, (i.e., army personals, medics, etc.) in case of potential presence of biological warfare agents such as Anthrax, BT, Sarin, Small Pox, and SARS, etc. The compositions of the invention can be used for disinfecting military vehicles, airplanes, and others. The compositions of the invention can be used to control the outbreak of infectious agents where, for example, they can be used to disinfect airlines (inside and outside), trains, buses and all sort of transportation means to control the spread of pathogens. The compositions of the invention can be used for to disinfect shoes (via a wipe of dipping or spraying) at airports and other ports of entry. The compositions of the invention can be used to control insects where, for example, they can be used as a spray to kill New Zealand Slug and other slugs or insects. The compositions of the invention can be used to kill fleas. The compositions of the invention can be used to control animal and insect pathogens where, for example, they can be used to control animal and bird viruses on hard surfaces and soft surfaces. Such viruses include SARS, bird flu virus, calicivirus, mad cow disease virus, parvovirus, feline viruses, etc. Also, they can be used to dip teats in to control various pathogens.

The composition may be part of a kit comprising a powder composition and a set of instructions. The powder composition may be on a nonwoven substrate. The set of instructions can be for use on soft inanimate surfaces (such as fabrics), hard inanimate surfaces (such as counter-tops), air (such as to destroy odors, germs, or allergens). The instructions can also be to prevent allergic response, to prevent illness, or a combination thereof.

The composition may be part of an article of manufacture wherein said article of manufacture in addition to the usage instructions bears an additional indication comprising a term selected from the group consisting of: healthy, healthier, reduce the occurrence of illness, control the spread of illness in the home, protect your family from illness, keep your home healthier, keep your family well, break the cycle of illness in the home, reduce the risk of common illnesses, and combinations thereof.

The composition may be part of an article of manufacture, wherein said article of manufacture in addition to the usage instructions bears an additional indication comprising a term selected from the group consisting of: neutralizes mold allergens, denatures toxins from mold, neutralizes toxins from mold, neutralizes protein allergens, controls allergens, removes allergens by cleaning, removes allergens by wiping, removes allergens in the laundry, reduces respiratory illness, reduces hay fever, reduces absenteeism, denatures mold allergens, prevents allergenic reactions, prevents allergenic reaction in humans, prevents allergenic symptoms due to mold, kills mold, destroys mold spores, destroys mold spores that cause adverse health effects, proven to prevent mold-triggered allergic sensitization in humans, proven to prevent mold-triggered allergic sensitization in animals, reduces the risk of mold-triggered allergic sensitization, reduces the risk of mold-triggered allergic response, destroys mold spores that induce allergic symptoms, neutralizes mold specific antigens, and prevents non-immune inflammatory reactions to mold.

The composition may be part of an article of manufacture. The article of manufacture may include a set of instructions. The set of instructions may be used with a method of instructing the public by providing to the public a set of instructions for the use of an article of manufacture comprising a container and a liquid composition comprising an allergen neutralizing agent selected from a group consisting of a hypohalous acid, a hypohalous acid salt, and a combination thereof; wherein said set of instructions comprises instructions to contact targets selected from a group consisting of hard surfaces, soft surfaces, or air with said liquid composition in its neat or diluted form to prevent allergic response, to prevent illness, or a combination thereof. The instructions may relate to preventing the spread of illness with a liquid composition comprising a hypohalous acid salt composition. The method of instructing the public may include information that an allergic response represents a response to pollen, dust mite, or mold allergens. The set of instructions may be provided to the public via electronic and/or print media. The set of instructions may be posted at the point of sale adjacent the package. The set of instructions may be posted on a global computer network at an address associated with products from a group consisting of said liquid composition, said target surface, or a combination thereof.

The method of promoting the use of the liquid composition comprising an allergen neutralizing agent selected from a group consisting of a hypohalous acid, a hypohalous acid salt, and a combination thereof may include use instructions to prevent allergic response and/or illness, the method comprising the step of informing the public that the treatment of targets selected from a group consisting of hard surfaces, soft surfaces, or air with said composition reduces and/or prevents allergic response and/or illness. The method of promoting the use of the composition may include the step of informing the consumer via electronic and/or print media.

The use of the composition may include an in vivo test method for testing allergic response in animals, wherein said test method comprises the subcutaneous injection of allergens treated with a composition selected from a group consisting of a hypohalous acid, a hypohalous acid salt, and a combination thereof.

Potential uses for the inventive packaging, compositions, and methods include dishwashing, for example U.S. Pat. Appl. 2003/0216271 to Scheper et al.; hospital environments and medical instruments, for example U.S. Pat. No. 6,632,347 to Buckley et al. and U.S. Pat. No. 6,126,810 to Fricker et al.; wound healing, for example U.S. Pat. Appl. 2003/0185704 to Bernard et al. and U.S. Pat. No. 6,426,066 to Najafi et al.; disinfecting or sterilizing objects such as medical instruments, for example U.S. Pat. No. 6,623,695 to Malchesky et al.; disinfecting and deodorizing the air, for example U.S. Pat. Appl. 2002/0179884 to Hoshino et al.; for water purification, for example U.S. Pat. No. 6,296,744 to Djeiranishvili et al.; removal of mold and mildew, for example U.S. Pat. No. 5,281,280 to Lisowski et al.

### EXAMPLES

Co-pending application Ser. No. 10/828,571, filed Apr. 20, 2004 discloses factors in the chemical composition that affect the stability of dilute hypohalous acid and hypohalous acid salt compositions, and is incorporated by reference. The stability of these compositions is also affected by packaging and manufacturing materials.

Aerosil R812S® from and Cab-O-Sil TS 720® from have adequate substitution of surface silanol groups to convert solutions with 0-7% NaOCl with a pH below about 11.8 to powders, as seen in Tables 1 and 2. Aerosil R812® has less carbon than Aerosil R812S® which indicates Aerosil R812® has more unblocked surface silanol groups. The results with Aerosil R812® are shown in Table 3.

TABLE 1

| | Hypochlorite Solution | | | | | |
|---|---|---|---|---|---|---|
| | | | | % | Cab-O-Sil TS 720 | |
| | % | | | NaOCl in | | % in |
| Trial | NaOCl | pH | g used | powder | g used | powder |
| 1 | 0.0100 | 5.14 | 38.99 | 0.0095 | 2.00 | 4.88 |
| 2 | 0.0205 | 6.81 | 41.67 | 0.0198 | 1.54 | 3.56 |
| 3 | 0.0205 | 7.00 | 202.49 | 0.0196 | 9.13 | 4.31 |
| 4 | 0.0202 | 7.54 | 40.77 | 0.0193 | 2.08 | 4.85 |
| 5 | 0.0204 | 9.45 | 42.05 | 0.0194 | 2.07 | 4.69 |
| 6 | 1.60 | 9.17 | 40.42 | 1.53 | 2.04 | 4.80 |
| 7 | 6.33 | 10.38 | 46.00 | 6.04 | 2.19 | 4.54 |
| 8 | 6.33 | 11.06 | 47.58 | 6.05 | 2.17 | 4.36 |
| 9 | 6.33 | 11.41 | 44.81 | 6.05 | 2.05 | 4.37 |
| 10 | 6.33 | 11.87 | 40.20 | 6.02 | 2.04 | 4.83 |

TABLE 2

| | Hypochlorite Solution | | | | | | |
|---|---|---|---|---|---|---|---|
| | | | | % NaOCl | Aerosil R812S | | |
| | % | | | in | | % in | |
| Trial | NaOCl | pH | g used | powder | g used | powder | Powder |
| 1 | 0.0100 | 5.14 | 40.00 | 0.0096 | 1.81 | 4.33 | Yes |
| 2 | 0.0205 | 6.81 | 52.02 | 0.0198 | 1.77 | 3.29 | Yes |
| 3 | 0.0205 | 7.00 | 227.62 | 0.0196 | 10.14 | 4.26 | Yes |
| 4 | 0.0205 | 6.81 | 496.82 | 0.0197 | 20.63 | 3.99 | Yes |
| 5 | 0.0981 | 5.21 | 40.66 | 0.0939 | 1.80 | 4.24 | Yes |
| 6 | 0.991 | 11.43 | 40.44 | 0.945 | 1.95 | 4.59 | Yes |
| 7 | 6.33 | 11.37 | 40.12 | 6.00 | 2.20 | 5.20 | Yes |
| 8 | 6.33 | 11.55 | 40.51 | 6.03 | 2.01 | 4.73 | Yes |

TABLE 3

| | Hypochlorite Solution | | | | Aerosil R812 | | |
|---|---|---|---|---|---|---|---|
| | % | | | % NaOCl | | % in | |
| Trial | NaOCl | pH | g used | in powder | g used | powder | powder |
| 1 | 0.412 | 3.39 | 42.79 | 0.394 | 2.04 | 4.86 | Yes |
| 2 | 0.264 | 3.39 | 41.99 | 0.251 | 2.15 | 4.86 | Yes |
| 3 | 0.694 | 4.60 | 40.05 | 0.661 | 1.97 | 4.69 | Yes |
| 4 | 0.303 | 4.80 | 42.40 | 0.289 | 2.05 | 4.86 | Yes |
| 5 | 0.0100 | 5.14 | 39.41 | 0.0095 | 1.99 | 4.81 | Yes |
| 6 | 0.0981 | 5.21 | 40.49 | 0.0934 | 2.01 | 4.73 | Yes |
| 7 | 0.345 | 5.51 | 42.71 | 0.329 | 2.09 | 4.86 | Yes |
| 8 | 0.0202 | 5.80 | 125.37 | 0.0192 | 6.50 | 4.93 | Yes |
| 9 | 0.206 | 5.81 | 41.46 | 0.197 | 1.98 | 4.86 | Yes |
| 10 | 0.463 | 5.84 | 40.09 | 0.442 | 1.98 | 4.71 | Yes |
| 11 | 0.620 | 5.87 | 40.36 | 0.591 | 1.99 | 4.70 | Yes |
| 12 | 0.401 | 6.06 | 43.10 | 0.382 | 2.07 | 4.86 | Yes |
| 13 | 0.311 | 6.08 | 42.69 | 0.297 | 2.03 | 4.86 | Yes |
| 14 | 0.223 | 6.52 | 41.72 | 0.213 | 2.04 | 4.86 | Yes |
| 15 | 0.0202 | 7.54 | 125.08 | 0.0192 | 6.59 | 5.00 | Yes |
| 16 | 0.148 | 7.62 | 40.02 | 0.141 | 2.00 | 4.76 | Yes |
| 17 | 0.0204 | 9.45 | 125.06 | 0.0194 | 6.53 | 4.96 | Yes |

Cab-O-Sil TS 530® and HDK H2000® from are similar to Aerosil R812® and Aerosil R812S®, and powders of hypochlorite solutions have been made from these treated fumed silicas as seen in Table 4.

TABLE 4

| | Trial | | | | |
|---|---|---|---|---|---|
| | 1 | 2 | 3 | 4 | 5 |
| % NaOCl in solution | 0.0201 | 0.0201 | 6.20 | 0.0201 | 0.0201 |
| % Boric acid in | | | | 0.0995 | 0.0995 |
| solution | | | | | |
| pH of solution | 5.80 | 5.80 | 11.31 | 5.76 | 5.76 |
| Solution used, g | 40.19 | 40.75 | 40.31 | 125.29 | 125.30 |
| Aerosil R812S, g | | | 1.01 | 5.99 | |
| Aerosil R812, g | | | | | 6.65 |
| HDK H2000, g | | 2.28 | | | |
| Cab-O-Sil TS-530, g | 2.02 | | | | |
| Cab-O-Sil TS-720, g | | | 0.99 | | |
| % treated silica in | 4.79 | 5.30 | 4.73 | 4.56 | 5.04 |
| powder | | | | | |
| % NaOCl in powder | 0.0191 | 0.0190 | 5.91 | 0.0190 | 0.0189 |

Mixed using Omni GLH homogenizer with 20 mm disperser polypropylene jars
Aerosil R812S ® from Degussa AG
Cab-O-Sil TS 720 ® from Cabot Corp.
HDK H2000 ® from Wacker Chemical Corp.

The amount of treated silica required to convert salt solutions to powders is between 3 and 6% by weight of the final composition. Amounts greater than 6% can be used, but the excess does not participate in particle formation. The optimum amount depends on the pH and ionic strength of the salt solution and on the type and extent of treatment on the fumed silica. It may also depend on the method of production. With Aerosil R812S® and Cab-O-Sil TS 720® a suitable amount is 3.5-5.5 weight percent of the finished powder; or 4-5%. With less amount of treated silicas, the powder can be difficult to form, and with more the excess of treated silica may be present as a fine dust.

Powders have also been made using salts other than sodium hypochlorite (lithium chloride, magnesium sulfate, and potassium nitrate) and with mixtures of salts as shown in Table 5. It must be remembered that the sodium hypochlorite used in this work contains an equimolar amount of sodium chloride and a small amount of sodium carbonate.

TABLE 6
Powdered Salt Solutions Made With Aerosil R812S

| Salt Solution | | | Aerosil R812S | |
|---|---|---|---|---|
| Salt | mol/kg | g used | g used | % in powder |
| LiCl | 0.304 | 40.90 | 1.96 | 4.57 |
| K2SO4 | 0.371 | 39.74 | 1.95 | 4.70 |
| KNO3 | 0.482 | 39.83 | 1.95 | 4.69 |
| MgSO4.7H2O | 0.495 | 40.72 | 1.94 | 4.59 |

Mixed using Omni GLH homogenizer with 20 mm disperser in 4 oz polypropylene jar

The process of converting aqueous salt solutions to powders using treated fumed silica requires shear to break apart the silica agglomerates into their aggregates and to create 1-20 μm droplets of aqueous composition. The treated fumed silica aggregates spontaneously and coats these small water droplets to form the free-flowing powder. Particles as large as 30 μm are found, but most are often smaller than 10 μm.

Coated particles of salt solutions are typically formed within 10-200 seconds at 10,000-30,000 using a rotor-stator mixing head. Suitable is a laboratory homogenizer, either a Tekmar Tissuemiser with a 18-N disperser (generator), or an Omni GLH with a 20 mm disperser made of titanium. Rotor stator devices with one or more stages are also available for continuous production in which the salt solution and the treated fumed silica are feed directly into the mixing chamber. Coated powders can also be made using a high speed mixer with various styles of mixing blades. A solution of 0.0085% NaOCl at pH 7.5 was coated with 4.5% of Aerosil R812S® using an Osterizer 10-speed blender on the highest speed. Powders were also made by mixing a solution of 0.02% NaOCl at pH 6.81 with 4.17% Aerosil R812S® at high speed (7500 rpm) using a T-Line Model 101 Mixer with a 4-blade pitched turbine impeller in a straight sided container and by mixing a solution of 0.01% NaOCl at pH 5.1 with 4.16% Aerosil R812S® at high speed (7500 rpm) using a T-Line Model 103 Mixer with a 3-bladed hydrofoil impeller in a straight sided container. Other methods capable of breaking apart the silica agglomerates and forming water droplets smaller than about 20 μm are also suitable. These would include colloid mills, cavitation from ultra sonic generators and high shear fluid processors such as those made by Microfluidics. High shear fluid processors force liquids and powders through specially designed chambers at high pressure to form small particles using high shear and collision impact.

A nonwoven wipe with powdered hypochlorite was made as follows. A powder was made by mixing 50.7 g of a solution with 0.102% NaOCl at pH 5.15 with 50.93 g of deionized water and 4.88 g of Aerosil R812S® in a 250 mL polypropylene beaker. 1.38 g was spread over the surface of a 5″ square of nonwoven polypropylene that weighed 0.66 g (TO-524 PP SMS, 41 g/m² from BBA Nonwovens®). After shaking of the excess, 0.21 g of powder remained on the wipe. When rubbed on a counter, the hypochlorite solution was released to leave a thin layer of liquid.

Powdered hypochlorite was shown to disinfect hard surfaces as follows. A powder was made from 97.7 g of a solution with 0.0085% NaOCl at pH 7.5 and 4.49 g of Aerosil R812S® using a Tekmar Tissuemiser with a 18-N disperser in a 250 mL polypropylene beaker. This was used to kill bacteria on ceramic tile. A culture of Klebsiella species was applied to 2″ diameter circles in the middle of a series of 4″ square black ceramic tiles and allowed to dry. These tiles various treatments with a contact time of four minutes. After four minutes, the center of the tiles were rubbed with a swab that was saturated with soium thiosulfate solution and then touched to the center of an agar plate. The agar plates were sealed and incubated over night at ambient temperature. The next day they were checked for microbial growth. The untreated control had bacterial growth, TNTC. The positive control from a tile that was sprayed with a 2% solution of sodium hypochlorite had no bacterial growth. Bacterial growth, TNTC, was observed when powdered hypochlorite was applied to a tile without rubbing, so no liquid was released from the powder. When the powder was applied to a disposable lab wipe and the treated wipe was used to wipe the tile a few times, liquid was released, and no bacterial growth was observed on the agar plate. The test was repeated with two other types of bacteria, Staphococcus species, and Escherica coli. The powdered bleach was made from 95.46 g of hypochloriote solution and 4.86 g of Aerosil R812S® as before. The results were the same with both types of bacteria. The untreated control had bacterial growth, TNTC, and the positive control which was treated with 2% NaOCl had no growth. Either 0.25 g of powdered hypochlorite was applied directly to the tile and then wiped or 0.25 g of powdered hypochlorite was applied to a lab wipe which was then used to wipe the tile. In both cases there was no growth on the agar plates. An additional test was done in which the tile was rubbed only with a clean lab wipe had bacterial growth, TNTC.

Hypochlorous acid vapors emitted from powdered hypochlorite or from hypochlorite solutions also inhibited mold growth inside sealed Gladware® containers. A 80 mm i.d. mold plate was filed with potato dextrose gel and placed inside a 739 mL Gladware Entree® container, with inside dimensions of 155 mm×155 mm×50 mm deep. A 10 mL glass beaker with the hypochlorite source was also placed inside the container. The lid was placed on top of the container and a swab which had been contaminated with Penicillium species was inserted beneath the lid and shook. The swab was removed and the lid was sealed. The containers were incubated four days at room temperature and visually evaluated for mold growth. The control with no hypochlorite source was completely covered with mold. The container with 2 g of a 0.1% NaOCl solution at pH 5.2 had very little if any mold growth. The containers with 0.5 g of the same hypochlorite solution diluted with 0.5 g of deionized water or with 1 g of a powder made from 50.7 g of the above hypochlorite solution, 50.93 g of deionized water and 4.88 g of Aerosil R812S® had a little mold growth, but much less than the control. These two treatments were nearly identical, which shows the partial pressure of hypochlorous acid in the powder is similar to that of the solution. Thus, increasing the amount of powder or hypochlorite concentration in the powder will completely control the mold as observed in the first treatment. Other treatments had either 0.5 g of the powder described above, or 1 g of a powder made from 95.46 g of a solution with 0.0085% NaOCl at pH 7.5 and 4.86 g of Aerosil R812S®.

Powdered hypochlorite can also be used to pretreat laundry. A powder was made by mixing 60.04 g of a solution with 0.05% NaOCl at pH 5.5 with 2.89 g of Aerosil R812S®. Stained flags were treated by applying ¼ teaspoon (about 0.7 g) to each stain and scrubbing 30 times. After 5 minutes six flags, including untreated flags, were added to a typical top loading washing machine with 69 L of 93° F. and 92.4 g of Liquid Tide® Laundry Detergent. After a normal 12 minute wash the flags were rinsed with 68° F. water and then dried. Stain removal was determined from calorimetric reflectance readings taken before treatment and after drying and converted to % SR(E). The respective % SR(E) for the treated and the control flags for fountain pen ink were 60 and 50, for ball point pen ink were 95 and 35, and for sebum were 73 and 66. Thus, the powdered hypochlorite significantly improved the removal of these stains.

This invention has been described herein in considerable detail to provide those skilled in the art with information relevant to apply the novel principles and to construct and use such specialized components as are required. However, it is to be understood that the invention can be carried out by different equipment, materials and devices, and that various modifications, both as to the equipment and operating procedures, can be accomplished without departing from the scope of the invention itself. As such, these changes and modifications are properly, equitably, and intended to be, within the full range of equivalence of the following claims.

1. A powder comprising:
a. greater than 10% water;
b. a hypohalite compound; and
c. an inorganic solid.

2. The powder of claim 1, wherein said powder comprises greater than 50% water.

3. The powder of claim 1, wherein said powder comprises greater than 70% water.

4. The powder of claim 1, wherein said powder comprises greater than 80% water.

5. The powder of claim 1, wherein said powder comprises greater than 90% water.

6. The powder of claim 1, wherein said inorganic solid comprises fumed silica.

7. The powder of claim 1, wherein said inorganic solid comprises hydrophobically modified fumed silica.

8. A powder comprising:
a. greater than 50% water;
b. a compound selected from the group consisting of hypochlorite, hypochlorous acid, and combinations thereof; and
c. silica.

9. The powder of claim 8, wherein said powder comprises greater than 1% silica.

10. The powder of claim 8, wherein said powder comprises greater than 2% silica.

11. The powder of claim 8, wherein said powder comprises greater than 3% silica.

12. The powder of claim 8, wherein said powder comprises greater than 4% silica.

13. The powder of claim 8, wherein said powder comprises greater than 0.5% of said hypohalite compound selected from the group consisting of hypochlorite, hypochlorous acid, and combinations thereof.

14. The powder of claim 8, wherein said powder comprises less than 0.5% of said hypohalite compound selected from the group consisting of hypochlorite, hypochlorous acid, and combinations thereof.

15. A kit comprising
a. a powder composition; and
b. a set of instructions;
c. wherein said powder composition comprises greater than 50% water and a hypohalite compound.

16. The kit of claim 15, wherein said powder composition additionally comprises fumed silica.

17. The kit of claim 15, wherein said powder composition is incorporated into a nonwoven substrate.

18. The kit of claim 15, wherein said set of instructions includes instructions for use on soft inanimate surfaces.

19. The kit of claim 15, wherein said set of instructions includes instructions for use on hard inanimate surfaces.

20. The kit of claim 15, wherein said set of instructions includes instructions for use on animate surfaces.

21. The kit of claim 15, wherein said set of instructions includes instructions for use in treating air.

22. The kit of claim 15, wherein said set of instructions includes instructions for deactivating allergens.
